(19) United States
(12) Patent Application Publication
(10) Pub. No.: US 2009/0205493 A1
(43) Pub. Date: Aug. 20, 2009

(54) Method of removing water from an inlet region of an oxygen generating system

(76) Inventors: Loren M. Thompson, Lapeer, MI (US); Robert R. Voltenburg, JR., Davison, MI (US); Andrew M. Voto, Brighton, MI (US); James H. Youngblood, Highland, MI (US); Michael S. McClain, Ortonville, MI (US)

Correspondence Address: DELPHI TECHNOLOGIES, INC., M/C 480-410-202, PO BOX 5052, TROY, MI, 48007, US

(21) Appl. No.: 12/070,579

(22) Filed: Feb. 20, 2008

(51) Int. Cl. B01D 53/02; B01D 53/18

(52) U.S. Cl. 95/130; 96/108

(57) ABSTRACT

A method of removing water from an inlet region of an oxygen generating system is disclosed herein. The method includes condensing, in an inlet region of the oxygen generating system, at least a portion of water vapor from a feed gas to water, and removing the water from the oxygen generating system prior to introducing the then-at least partially dehumidified feed gas to at least one sieve bed operatively disposed in the oxygen generating system.

### BACKGROUND

The present disclosure relates generally to oxygen generating systems.

Oxygen generating systems are often used to produce an oxygen-enriched gas for a user. Oxygen generating systems typically include a gas fractionalization system configured to separate oxygen from other components (e.g., nitrogen) in a feed gas to produce the oxygen-enriched gas. The gas fractionalization system, for example, may include one or more sieve beds having a nitrogen-adsorption material disposed therein and configured to adsorb at least nitrogen from the feed gas.

The feed gas, in many oxygen generating systems, also includes at least oxygen and water vapor. The feed gas is often compressed prior to the nitrogen-adsorption process, and tends to have relatively high water content. However, the water, when it comes into contact with the nitrogen-adsorption material, may, in some instances, contaminate or otherwise potentially compromise the adsorption/desorption capabilities of the nitrogen-adsorption material. As a result, difficulties may arise in achieving desirable purity levels of oxygen in the oxygen-enriched gas.

### SUMMARY

A method of removing water from an inlet region of an oxygen generating system is disclosed herein. The method includes condensing, in an inlet region of the oxygen generating system, at least a portion of water vapor from a feed gas to water, and removing the water from the oxygen generating system prior to introducing the then-at least partially dehumidified feed gas to at least one sieve bed operatively disposed in the oxygen generating system.

### BRIEF DESCRIPTION OF THE DRAWINGS

Features and advantages of the present disclosure will become apparent by reference to the following detailed description and drawings, in which like reference numerals correspond to similar, though not necessarily identical components. For the sake of brevity, reference numerals or features having a previously described function may or may not be described in connection with other drawings in which they appear.

FIG. 1 is a schematic diagram of an exemplary oxygen generating system;

FIG. 2 is a schematic diagram of another exemplary oxygen generating system;

FIG. 3 is a semi-schematic, perspective, cut-away view of an embodiment of an inlet region of an oxygen generating system;

FIG. 4 is a semi-schematic, cut-away side view of the inlet region of FIG. 3;

FIG. 5 is a semi-schematic, perspective, cut-away view of an embodiment of a sieve module showing respective inlet regions of an oxygen generating system having two sieve beds;

FIG. 6 is a semi-schematic, enlarged, perspective, cut-away, cross-sectional view, taken along line 6-6 of FIG. 5;

FIG. 7 is a semi-schematic, perspective, cut-away view of another embodiment of an inlet region of an oxygen generating system; and

FIG. 8 is a semi-schematic, perspective, cut-away view of yet another embodiment of an inlet region of an oxygen generating system.

### DETAILED DESCRIPTION

Embodiment(s) of the method disclosed herein advantageously remove at least a portion of the water/water vapor from the feed gas (e.g., compressed feed gas) prior to entering the sieve bed(s) in the oxygen generating system. This may be accomplished by condensing at least a portion of the water vapor present in a feed gas into water prior to supplying the at least partially dehumidified feed gas to the sieve bed(s), and then removing the condensed water from the oxygen generating system. The condensed water may be removed during venting of nitrogen-enriched gas generated during a nitrogen-adsorption process performed by the oxygen generating system. Removal of the water from the compressed feed gas stream may be particularly advantageous in those systems that are used in environments having substantially high relative humidity. Also, with less water present in the feed gas stream, the life of the nitrogen-adsorption material employed by the sieve bed(s) for the nitrogen-adsorption process may be extended, and a higher purity of oxygen in the oxygen-enriched gas may be achieved.

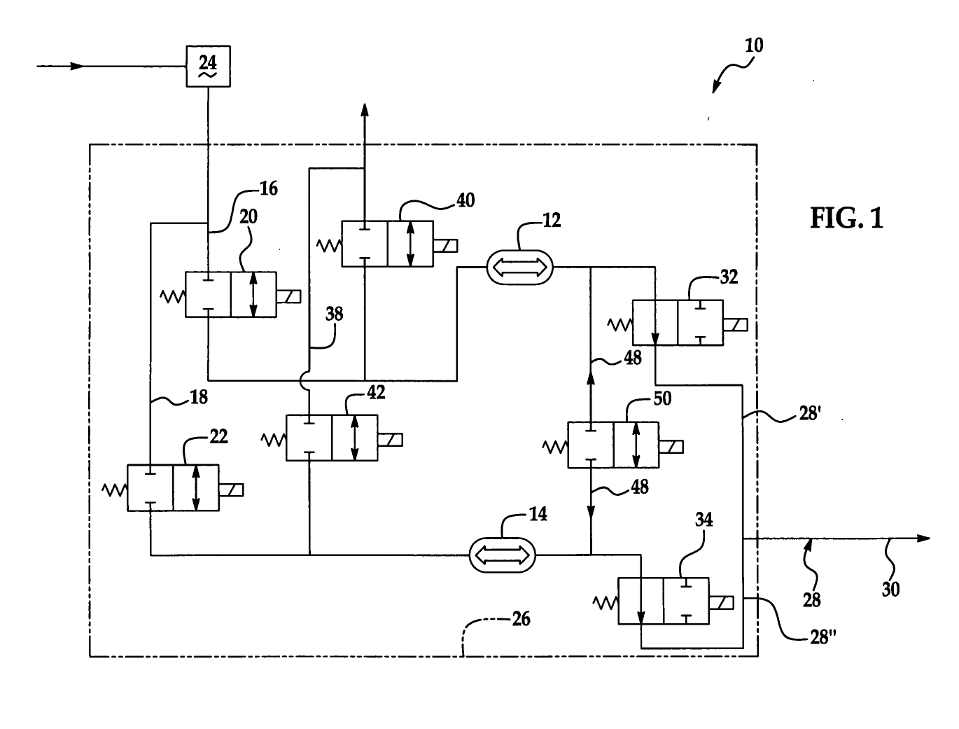

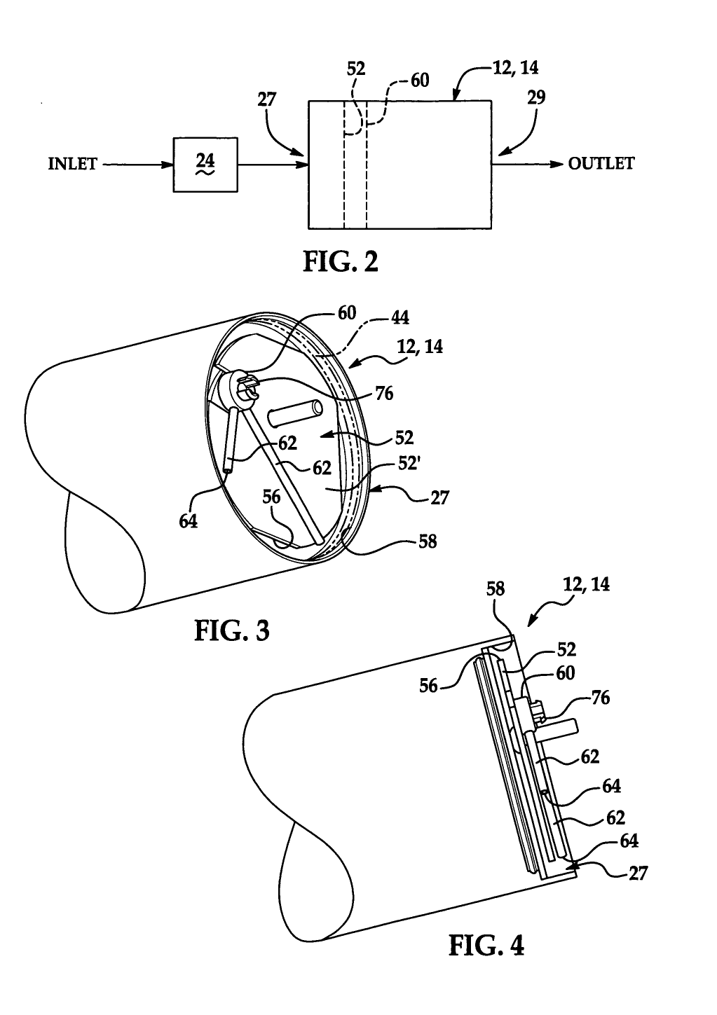

One non-limiting example of an oxygen generating system suitable for use with embodiment(s) of the method(s) and device(s) disclosed herein is depicted in FIG. 1. However, it is to be understood that any oxygen generating system may be suitable for use with the embodiment(s) of FIGS. 2-8, various examples of which (not shown) are oxygen generating system(s) having fill valves (any suitable combination of 2-way, 3-way, 4-way valves, etc.), vent valves (any suitable combination of 2-way, 3-way, 4-way valves, etc.), a product tank(s), bleed orifice(s) and patient valving.

It is to be understood that the nitrogen-adsorption process employed by the oxygen generating system may be a pressure swing adsorption (PSA) process or a vacuum pressure swing adsorption (VPSA) process, and such processes operate in repeating adsorption/desorption cycles. The oxygen generating system includes at least one sieve bed. In the example shown in FIG. 1, the oxygen generating system 10 includes first 12 and second 14 sieve beds, each in selective fluid communication with a feed gas including at least oxygen, nitrogen, and water vapor. In a non-limiting example, the feed gas is air taken from the ambient atmosphere outside of the system 10. In an embodiment, each of the first 12 and second 14 sieve beds are configured to selectively receive the feed gas during a predetermined supply period. The first 12 and second 14 sieve beds may receive the feed gas via first 16 and second 18 supply conduits, respectively.

The first 16 and second 18 supply conduits are generally operatively connected to respective first 20 and second 22 supply valves (or inlet valves). In a non-limiting example, the first 20 and second 22 supply valves are two-way valves. As provided above, the nitrogen-adsorption process employed by the oxygen generating system 10 operates via cycles, where one of the first 12 or second 14 sieve beds vents purge gas (i.e. nitrogen-enriched gas), while the other of the first 12 or second 14 sieve beds delivers generated oxygen-enriched gas to the user. During the next cycle, the functions of the respective sieve beds 12, 14 switch. Switching is accomplished by opening the respective feed gas supply valve 20, 22 while the other of the supply valves 20, 22 is closed. In an embodiment, the opening and/or closing of the first 20 and second 22 supply valves may be controlled with respect to timing of opening and/or closing and/or with respect to the sequence in with the first 20 and second 22 supply valves are opened and/or closed.

In an embodiment, the feed gas is compressed via, e.g., a compressor 24 prior to entering the first 16 or second 18 supply conduits. In a non-limiting example, the compressor is a scroll compressor. It is to be understood, however, that compression of the feed gas may be accomplished by any suitable compression means.

After receiving the feed gas, the first 12 and second 14 sieve beds are each configured to separate at least most of the oxygen from the feed gas to produce the oxygen-enriched gas. In an embodiment, the first 12 and second 14 sieve beds are each sieve beds 12, 14 including the nitrogen-adsorption material (e.g., zeolite, other similar suitable materials, and/or the like) configured to adsorb at least nitrogen from the feed gas. As schematically shown in phantom in FIG. 2, the sieve beds 12, 14 are operatively disposed in a housing and, taken as a whole, is generally referred to herein as a sieve module 26.

Referring again to FIG. 2, the oxygen generating system 10 includes an inlet region 27 located in a flow path after the compressor 24 and prior to the sieve beds 12, 14, and an outlet region 29 located in a flow path after the sieve beds 12, 14. In a non-limiting example, the inlet region 27 is located at an end of the sieve beds 12, 14 in the sieve module 26, while the outlet region 29 is located at an opposite end of the sieve beds 12, 14.

In a non-limiting example, the oxygen-enriched gas generated via either the PSA or VPSA processes includes a gas product having an oxygen content ranging from about 70 vol % to about 100 vol % of the total gas product. In another non-limiting example, the oxygen-enriched gas has an oxygen content of at least 87 vol % of the total gas product.

Referring back to FIG. 1, a user conduit 28 having a user outlet 30 is in alternate selective fluid communication with the first and second sieve beds 12, 14. The user conduit 28 may be formed from any suitable material, e.g., at least partially from flexible plastic tubing. In an embodiment, the user conduit 28 is configured substantially in a “Y” shape. As such, the user conduit 28 may have a first conduit portion 28′ and a second conduit portion 28″, which are in communication with the first sieve bed 12 and the second sieve bed 14, respectively, and merge together before reaching the user outlet 30. The user outlet 30 may be an opening in the user conduit 28 configured to output the substantially oxygen-enriched gas for user use. The user outlet 30 may additionally be configured with a nasal cannula, a respiratory mask, or any other suitable device, as desired.

The first conduit portion 28′ and the second conduit portion 28″ may be configured with a first user delivery valve 32 and a second user delivery valve 34, respectively. In an embodiment, the first 32 and the second 34 user valves are configured as two-way valves. It is contemplated that when the oxygen-enriched gas is delivered from one of the first and second sieve beds 12, 14, to the user conduit 28, the respective one of the first 32 or second 34 user valves is open. Further, when the respective one of the first 32 or second 34 user valves is open, the respective one of the first 20 or second 22 feed gas supply valves is closed.

The nitrogen-adsorption process selectively adsorbs at least nitrogen from the feed gas. Generally, the compressed feed gas is introduced into one of the first 12 or the second 14 sieve beds, thereby pressurizing the respective first 12 or second 14 sieve bed. Nitrogen and possibly other components present in the feed gas are adsorbed by the nitrogen-adsorption material disposed in the respective first 12 or second 14 sieve bed during an appropriate PSA/VPSA cycle. After: a predetermined amount of time; reaching a predetermined target pressure; detection of an inhalation; and/or another suitable trigger, the pressure of the respective first 12 or second 14 sieve bed is released. At this point, the nitrogen-enriched gas (including any other adsorbed components) is also released from the respective first 12 or second 14 sieve bed and is vented out of the system 10 through a vent port/conduit for the respective first 12 or second 14 sieve bed. As shown in FIG. 1, the nitrogen-enriched gas in the first sieve bed 12 is vented through the vent conduit 36 when a first vent valve 40 is open, and the nitrogen-enriched gas in the second sieve bed 14 is vented through the vent conduit 38 when a second vent valve 42 is open. It is to be understood that venting occurs after each dynamically adjusted oxygen delivery phase and after counterfilling, each of which will be described further below. The gas not adsorbed by the nitrogen-adsorption material (i.e., the oxygen-enriched gas) is delivered to the user through the user outlet 30.

In an embodiment, delivery of the oxygen-enriched gas occurs during or within a predetermined amount of time after the dynamically adjusted oxygen delivery phase from the respective first 12 or second 14 sieve bed. For example, the oxygen delivery system 10 may be configured to trigger an output of a predetermined volume of the oxygen-enriched gas from the sieve bed 12 upon detection of an inhalation by the user. Detection of an inhalation may be accomplished by any suitable means. The predetermined volume, which is at least a portion of the oxygen-enriched gas produced, is output through the user conduit 28 and to the user outlet 30 during a respective dynamically adjusted oxygen delivery phase.

The first 12 and second 14 sieve beds are also configured to transmit at least a portion of the remaining oxygen-enriched gas (i.e., the oxygen-enriched gas not delivered to the user during the delivery phase to the user outlet 30), if any, to the other of the first 12 or second 14 sieve bed. This also occurs after each respective dynamically adjusted oxygen delivery phase. The portion of the remaining oxygen-enriched gas may be transmitted via a counterfill flow conduit 48. The transmission of the remaining portion of the oxygen-enriched gas from one of the first 12 or second 14 sieve beds to the other first 12 or second 14 sieve beds may be referred to as “counterfilling.”

As shown in FIG. 1, the counterfill flow conduit 48 may be configured with a counterfill flow valve 50. In a non-limiting example, the counterfill flow valve 50 is a two-way valve. The counterfill flow valve 50 is opened to allow the counterfilling of the respective first 12 and second 14 sieve beds.

Embodiments of the method of removing water from the inlet region 27 of the oxygen generating system 10 are depicted in FIGS. 3-8. The method generally includes condensing, in the inlet region 27, at least a portion of the water vapor from the feed gas to water, and removing the water from the oxygen generating system 10.

In an example, at least a portion of the water vapor may be condensed into water by: compressing the feed gas including the water vapor via, e.g., the compressor 24 prior to entering the inlet region 27; and when the compressed feed gas flows into the inlet region 27 (a region of substantially larger volume than that of the supply conduits 16, 18), the compressed feed gas expands, rapidly cools and condenses at least a portion of the water vapor therein.

Condensing the water vapor in the feed gas may further be accomplished by impinging a stream of the feed gas against a surface at a velocity sufficient to accomplish the condensing.

In an embodiment, as shown in FIGS. 3-6, the surface is a substantially flat plate 52 disposed in the oxygen generating system 10 substantially adjacent to the inlet region 27 (as shown in FIG. 2) and spaced from a grid plate/cover 57 (as seen in FIG. 6) in contact with the nitrogen adsorbent material (e.g. zeolite). The plate 52 is generally configured to deflect the feed gas when the feed gas impinges it, and facilitates condensation of substantially most, if not all, of the water vapor remaining in the compressed feed gas stream. When the water vapor impinges the plate 52, at least a portion of it condenses, and water forms on the surface of the plate 52.

The plate 52 may further be designed to promote or facilitate condensing of the water vapor into water. For example, the plate 52 may be geometrically designed to promote condensing. Non-limiting examples of such geometric designs include designs that would impinge the natural feed gas flow. For example, the plate 52 may be formed in a grid- or labyrinth-type structure, and/or may have grooves, channels or dimples defined therein. Without being bound to any theory, it is believed that the more the gas is caused to impact a surface and change direction, the more water may be mechanically driven out of the feed gas stream. This is generally balanced against unduly limiting total gas flow by adding such restrictions. In an embodiment, plate 52 is a substantially flat plate with a substantially smooth surface, wherein water collects on the surface of plate 52 and runs off to the lowest point (condensate collection location) in the system 10 via gravity.

In another example, the plate 52 may be formed from a material having a surface finish configured to promote condensing. As mentioned above, the surface finish may be substantially smooth. However, in other examples, the plate 52 may have a rough surface finish to create more flow restriction and cause more water to be driven out of the gas stream impacting it. This is again balanced against preventing too rough of a surface finish such that the surface of plate 52 actually undesirably retains water thereon and prevents gravity from pulling it down to the collection location(s).

In an example, the feed gas stream is directed substantially perpendicularly against the surface 52′ (shown in FIG. 3) and then is deflected by plate 52. The feed gas deflection flow and water flow are shown in FIG. 6.

In yet a further example, the plate 52 may be cooled to promote condensing of the water vapor into water. Any temperature cooler than the temperature inside the sieve bed will generally promote condensing of the water vapor into water, since the gas will be saturated. Cooling may be accomplished during a venting stage of a cycle of the nitrogen-adsorption process, and/or may be accomplished via, e.g., an external cooling device (not shown). Non-limiting examples of suitable cooling devices include Pelletier cells, heat exchangers, radiators for the compressed gas (with or without a cooling fan), refrigerated cooling coils, systems similar to air conditioners, or the like, or combinations thereof. It is to be understood that the cooling device may be located in any suitable area and operatively connected by any suitable means. In an example, the cooling device may be implemented pneumatically between the compressor 24 and an inlet to the sieve bed 12, 14.

In a further alternate example, the plate 52 may include at least a hydrophilic layer and a hydrophobic layer. As such, one surface (hydrophobic) of plate 52 that is impacted by the gas will tend to repel water, and will thus not have a tendency to restrict air flow. The other surface (hydrophilic) of plate 52 may be operatively joined behind the hydrophobic surface, or next to it, so as to attract the water thereto and direct it to the water evacuation location. In yet a further example, the plate 52 may be formed from a composite of both hydrophilic and hydrophobic materials in the shape of a spiral, grid or stripes to direct the water to a desired evacuation location.

The plate 52 may also be configured to direct the condensed water to at least one pre-selected condensate collection location/area in the oxygen generating system 10. For example, plate 52 may include grooves or channels defined therein to direct the water (in some examples, at least partially against gravity) to a desired location. In a non-limiting example, the pre-selected location(s)/area(s) include those in which the condensed water is capable of being collected, e.g., a lowest gravitational area(s) of the system 10. In an embodiment, the location may be located at the periphery of the surface 52 and is defined by an edge 56 of the plate 52 and a wall 58 of the inlet region 27.

The condensed water may be removed from the system 10 via venting methods described further immediately below; e.g., the water may be removed from the oxygen generating system 10 via the venting port 36, 38 during the venting stage of each cycle of the nitrogen-adsorption process. In addition or alternately, the condensed water may be removed via an evacuation opening 70 defined in the inlet region 27 (as seen in FIG. 8). Opening 70 may be connected via a conduit 74 to an external pump, siphon, and/or the like.

In an alternate example, the water may be withdrawn from the condensate collection location via a vacuum. The vacuum draws the water from the condensate collection location and expels the water, in addition to the nitrogen-enriched gas produced in the sieve beds 12, 14, through the venting port 36, 38, and out to the atmosphere.

In an embodiment, the vacuum draws the condensate into a venturi 60, which is operatively disposed in the inlet region 27 (as shown in FIG. 2). The venturi 60 includes at least one evacuation tube 62 in fluid communication therewith, the venturi 60 being substantially perpendicular to the at least evacuation tube 62 at an intersection I (shown in FIG. 6) thereof. In the non-limiting examples shown in the Figures, two evacuation tubes 62 are depicted. It is to be understood, however, that any suitable number of evacuation tubes 62 may be used to accomplish desired removal of the water from the condensate collection location.

In use, the evacuation tubes 62 draw the condensed water away from the condensate collection location and into the venturi 60. Flow of nitrogen-enriched gas (i.e. purge gas) through the venturi 60 creates a vacuum that draws the condensed water out of the evacuation tubes 62. The water is incorporated with the flow of purge gas in the venturi 60, and is then expelled through the venting ports 36, 38, and out to the atmosphere (as provided above).

It is to be understood that the venturi 60 may be connected in fluid communication with venting port(s) 36, 38 by any suitable means. In an example (as shown in FIG. 6), venturi 60 has snap feature(s) 76 operatively connected thereto or integrally formed therewith. Snap feature(s) 76 are configured to matingly engage with the venting port 36, 38 defined in header plate/end plate 72 (port(s) 36, 38 and end plate 72 are each shown in phantom in FIG. 6). In an alternate example, venturi 60 may be integral with, or a part of the venting port 36, 38.

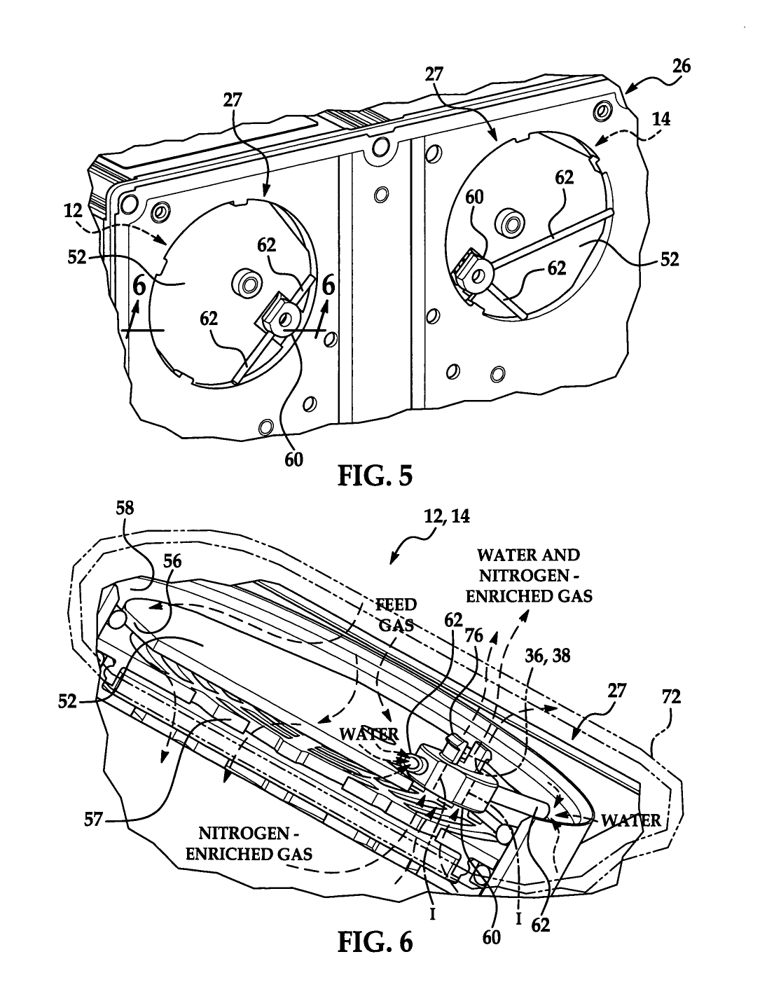

Referring also to FIGS. 3 and 4, the evacuation tubes 62 may be selectively arranged in the inlet region 27 so that the evacuation tubes 62 are located at a substantially lowest gravitational region of the inlet region 27 of the oxygen generating system 10. In an example, as shown in FIG. 5, the inlet region 27 includes each venturi 60 operatively disposed in a notch in deflector plate 52, the venturis 60 being in two different positions; one position for the sieve bed 12 and another position for the sieve bed 14. The venturi 60 for each of the sieve beds 12, 14 may be positioned so that the evacuation tubes 62 are selectively arranged at generally the lowest gravitational point in the oxygen generating system 10. It is to be understood that the position of the venturi 60 and the arrangement of the evacuation tubes 62 as depicted for the sieve beds 12, 14 in FIG. 5 are exemplary. It is further to be understood that several other positions for the venturi 60 and arrangements for the evacuation tubes 62 are also possible to accomplish substantially desirable removal of the water from the oxygen generating system 10.

In another example, the evacuation tubes 62 may be selectively arranged at the lowest gravitational region of the oxygen generating system 10 by applying weighting an end 64 of the evacuation tubes 62. For example, a weight (not shown) may be operatively disposed on the end 64 on tube(s) 62 distal to the intersection I at the venturi 60; and/or the tube(s) 62 could be fabricated such that they are heavier at the end 64. The weight would bias the evacuation tubes 62 to the lowest gravitational region without having to pre-position the venturi 60 so that the evacuation tubes 62 are positioned at the lowest gravitational region.

In yet another example, the evacuation tubes are selectively arranged in the oxygen generating system 10 at a position where a velocity of the nitrogen-enriched gas flowing through the venturi 60 during the venting stage of the nitrogen-adsorption process is substantially the highest. For example, forming a nozzle (not shown) on the purge gas venting port 36, 38 would generally increase gas velocity and produce a stronger suction on the tube(s) 62.

In another embodiment, the oxygen generating system 10 may further include one or more channels 44 (shown in phantom in FIG. 3) formed in the inlet region 27, e.g., defined in the interior wall 58 of the inlet region 27 and configured to collect the condensed water. The channel(s) may be configured to direct condensed water toward the ends 64 of tubes 62.

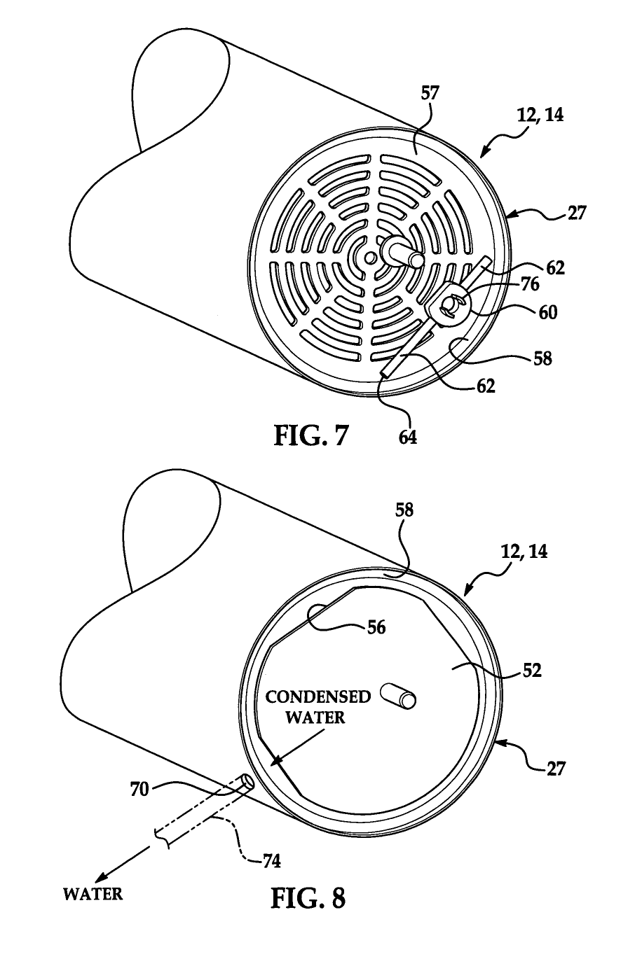

The embodiments of the method of removing the water from the inlet region 27 of the oxygen generating system 10 described in connection with FIGS. 3-6 include both the plate 52 and the venturi 60 having the evacuation tubes 62 operatively connected thereto. It is to be understood, however, that the method may alternatively employ 1) the venturi 60 with the evacuation tubes 62 without the plate 52 (as shown in FIG. 7), or 2) the plate 52 without the venturi 60 and the evacuation tubes 62 (as shown in FIG. 8).

With reference now to FIG. 7, an embodiment of the method of removing the water from the inlet region 27 includes condensing at least a portion of the water vapor into water by impinging the feed gas against a side wall 58 of the inlet region 27, and/or another suitable surface. The condensed water collects in the condensate collection location, and is withdrawn therefrom by the evacuation tubes 62 (as described above).

With reference to FIG. 8, another embodiment of the method includes condensing the water vapor into water by impinging the water against the plate 52. The condensed water collects in a condensate collection location and is withdrawn therefrom, e.g., through evacuation opening 70 and is expelled via, e.g., a sump valve, a sump pump, and/or the like. In a non-limiting example, withdrawing the water from the condensate collection location may be facilitated by tilting the plate 52 in a direction toward the evacuation opening 70 and allowing the water to drain via any of the means provided above.

It is to be understood that the term “connect/connected” is broadly defined herein to encompass a variety of divergent connection arrangements and assembly techniques. These arrangements and techniques include, but are not limited to (1) the direct connection between one component and another component with no intervening components therebetween; and (2) the connection of one component and another component with one or more components therebetween, provided that the one component being “connect to” the other component is somehow operatively connected to the other component (notwithstanding the presence of one or more additional components therebetween).

While several embodiments have been described in detail, it will be apparent to those skilled in the art that the disclosed embodiments may be modified and/or other embodiments may be possible. Therefore, the foregoing description is to be considered exemplary rather than limiting.

What is claimed is:

1. A method of removing water from an inlet region of an oxygen generating system, the oxygen generating system including at least one sieve bed configured to generate an oxygen-enriched gas for a user by adsorbing nitrogen via a nitrogen-adsorption process, the at least one sieve bed using a feed gas including at least water vapor, nitrogen, and oxygen, the method comprising:
condensing, in the inlet region, at least a portion of the water vapor from the feed gas into water, prior to supplying at least partially dehumidified feed gas to the at least one sieve bed; and
withdrawing the condensed water via a vacuum.

2. The method as defined in claim 1, further comprising collecting the water in a condensate collection location.

3. The method as defined in claim 2 wherein the water is collected by gravity.

4. The method as defined in claim 1 wherein the at least a portion of the water vapor is condensed by compressing the feed gas.

5. The method as defined in claim 1 wherein the oxygen generating system further includes a venting port operatively defined therein, and wherein the water, in addition to the adsorbed nitrogen, vents through the venting port.

6. The method as defined in claim 5 wherein the inlet region includes a venturi operatively disposed therein and in fluid communication with the venting port, the venturi including at least one evacuation tube in fluid communication therewith, the venturi being substantially perpendicular to the at least evacuation tube at an intersection thereof, and wherein the at least one evacuation tube is configured to draw the water away from the inlet region, into the venturi, and out the venting port.

7. The method as defined in claim 6 wherein the at least one evacuation tube is selectively arranged in the inlet region so that the at least one evacuation tube is located at a substantially lowest gravitational region of the oxygen generating system.

8. The method as defined in claim 7 wherein selectively arranging the at least one evacuation tube is accomplished by weighting an end of the at least one evacuation tube.

9. The method as defined in claim 6 wherein the at least one evacuation tube is selectively arranged in the oxygen generating system at a position where a velocity of the nitrogen through the venturi is substantially highest.

10. The method as defined in claim 5 wherein the inlet region includes one or more channels formed therein, the one or more channels being positioned and configured to direct water toward the at least one evacuation tube.

11. The method as defined in claim 1 wherein the removing the water is accomplished during a cycle of the nitrogen-adsorption process.

12. An oxygen generating system, comprising:
an inlet region configured to receive a feed gas including at least nitrogen, oxygen, and water vapor;
at least one sieve bed configured to generate an oxygen-enriched gas for a user, the oxygen-enriched gas being generated by adsorbing nitrogen from the feed gas via a nitrogen-adsorption process;
means, operatively disposed in the inlet region, for condensing at least a portion of the water vapor into water prior to supplying the at least partially dehumidified feed gas to the at least one sieve bed; and
means for withdrawing the condensed water via a vacuum.

13. The oxygen generating system as defined in claim 12, further comprising a condensate collection location configured to collect the condensed water.

14. The oxygen generating system as defined in claim 12 wherein the means for condensing includes a compressor.

15. The oxygen generating system as defined in claim 12, further comprising a venting port configured to vent the water and adsorbed nitrogen from the oxygen generating system.

16. The oxygen generating system as defined in claim 15, further comprising:
a venturi operatively disposed in the inlet region, the venturi being in fluid communication with the venting port; and
at least one evacuation tube in fluid communication with the venturi, the venturi being substantially perpendicular to the at least evacuation tube at an intersection thereof;
wherein the at least one evacuation tube is configured to draw the water away from the inlet region and into the venturi.

17. The oxygen generating system as defined in claim 16 wherein the at least one evacuation tube is selectively arranged in the inlet region so that the at least one evacuation tube is located at a substantially lowest gravitational region of the oxygen generating system.

18. The oxygen generating system as defined in claim 17 wherein the at least one evacuation tube includes a weight operatively disposed at an end area thereof, whereby the weight substantially biases the at least one evacuation tube toward the substantially lowest gravitational region.

19. The oxygen generating system as defined in claim 16 wherein the at least one evacuation tube is selectively arranged at a position in the oxygen generating system where a velocity of the nitrogen through the venturi is substantially highest.

20. The oxygen generating system as defined in claim 15, further comprising one or more channels formed in the inlet region, the one or more channels being positioned and configured to direct water toward the at least one evacuation tube.

21. A method of removing water from an inlet region of an oxygen generating system including at least one sieve bed configured to generate an oxygen-enriched gas for a user by adsorbing nitrogen via a nitrogen-adsorption process, the at least one sieve bed having a feed gas introduced thereto via an inlet, the feed gas including at least the nitrogen, water vapor, and oxygen, the method comprising:
condensing at least a portion of the water vapor into water by impinging the feed gas against a surface at a velocity sufficient to accomplish the condensing, the surface being disposed in the oxygen generating system substantially adjacent the inlet region, the condensing occurring prior to supplying the at least partially dehumidified feed gas to the at least one sieve bed; and
removing the condensed water from the oxygen generating system.

22. The method as defined in claim 21 wherein the surface is configured to deflect the feed gas, and wherein, when the feed gas deflects off the surface, the at least a portion of the water vapor condenses into water on the surface.

23. The method as defined in claim 22 wherein the surface is further configured to direct the water to at least one preselected area in the inlet region so that the water is capable of being collected in a condensate collection location.

24. The method as defined in claim 22 wherein the surface is at least one of: geometrically designed to promote condensing of the at least a portion of the water vapor into water; or made from at least one material having a surface finish configured to promote the condensing of the at least a portion of the water vapor into water.

25. The method as defined in claim 22, further comprising cooling the surface, thereby promoting the condensing of the at least a portion of the water vapor into water.

26. The method as defined in claim 25 wherein the oxygen generating system further includes a venting port, and wherein the cooling of the surface occurs during a venting stage of the nitrogen-adsorption process.

27. The method as defined in claim 22, further comprising withdrawing the water from the surface by tilting the surface in a direction toward an extraction opening defined in the inlet region.

28. The method as defined in claim 21 wherein the removing the water is accomplished during a cycle of the nitrogen-adsorption process.

29. An oxygen generating system, comprising:
an inlet region configured to receive a feed gas including at least nitrogen, oxygen, and water vapor;
at least one sieve bed configured to generate an oxygen-enriched gas for a user, the oxygen-enriched gas being generated by adsorbing nitrogen from the feed gas via a nitrogen-adsorption process;
a surface configured to facilitate condensation of the water vapor into water when the feed gas impinges the surface, the surface being disposed in the oxygen generating system substantially adjacent the inlet region; and
means for withdrawing the condensed water from the oxygen generating system.

30. The oxygen generating system as defined in claim 29 wherein the surface is further configured to deflect the feed gas, and wherein, when the feed gas deflects off the surface, the at least a portion of the water vapor condenses into water on the surface.

31. The oxygen generating system as defined in claim 30 wherein the surface is further configured to direct the water to at least one preselected position in the oxygen generating system so that the water is capable of being collected in a condensate collection location.

32. The oxygen generating system as defined in claim 30 wherein the surface is at least one of: geometrically designed to promote condensing of the at least a portion of the water vapor into water; or made from at least one material having a surface finish configured to promote condensing of the at least a portion of the water vapor into water.

33. The oxygen generating system as defined in claim 30 wherein the surface includes at least a hydrophilic layer and a hydrophobic layer, the hydrophilic layer configured to attract and direct condensed water toward an evacuation opening defined in the inlet region.

34. The oxygen generating system as defined in claim 30, further comprising a cooling device configured to cool the surface, thereby promoting condensing of the at least a portion of the water vapor into water.

35. A method of removing water from an inlet region of an oxygen generating system, the oxygen generating system including at least one sieve bed configured to generate an oxygen-enriched gas for a user by adsorbing nitrogen via a nitrogen-adsorption process, the at least one sieve bed using a feed gas including at least water vapor, nitrogen, and oxygen, the method comprising:
condensing, in the inlet region, at least a portion of the water vapor from the feed gas into water by impinging the feed gas against a surface at a velocity sufficient to accomplish the condensing, the surface being disposed in the oxygen generating system substantially adjacent the inlet region, the condensing occurring prior to supplying the at least partially dehumidified feed gas to the at least one sieve bed; and
withdrawing the condensed water via a vacuum.

36. The method as defined in claim 35 wherein the oxygen generating system includes a venting port operatively defined therein, and wherein the water, in addition to the adsorbed nitrogen, vents through the venting port.

37. The method as defined in claim 36 wherein the inlet region includes a venturi in operative contact with the surface and in fluid communication with the venting port, the venturi including at least one evacuation tube in fluid communication therewith, the venturi being substantially perpendicular to the at least evacuation tube at an intersection thereof, and wherein the at least one evacuation tube is configured to draw the water away from the inlet region, into the venturi, and out the venting port.

38. The method as defined in claim 37 wherein the surface is configured to deflect the feed gas, and wherein, when the feed gas deflects off the surface, the at least a portion of the water vapor condenses into water on the surface.
